(19) United States
(12) Patent Application Publication
(10) Pub. No.: US 2013/0047830 A1
(43) Pub. Date: Feb. 28, 2013

(54) ARTICLE COMPRISING POLYMERIC TAPES

(71) Applicants: Roelof Marissen, Born (NL); Leonard Josef Arnold Nielaba, Eygelshoven (NL)

(72) Inventors: Roelof Marissen, Born (NL); Leonard Josef Arnold Nielaba, Eygelshoven (NL)

(73) Assignee: DSM IP Assets B.V., Heerlen (NL)

(21) Appl. No.: 13/696,344

(22) PCT Filed: May 2, 2011
(86) PCT No.: PCT/EP2011/056974

§ 371 Date: Nov. 6, 2012

(30) Foreign Application Priority Data
May 6, 2010 (EP) 10162151.4

(51) Int. Cl. B32B 27/06; F41H 5/04; B32B 37/06; B32B 37/10; B32B 3/02; D03D 15/00

(52) U.S. Cl. 89/36.02; 428/411.1; 428/523; 428/339; 428/189; 442/301; 156/247; 114/102.31; 89/916

(57) ABSTRACT

The invention relates to a flexible article having resistance against ballistic impacts wherein said article comprises a stack of at least two unconnected plies, each ply containing at least two connected monolayers containing polymeric tapes and wherein said monolayers are free of any matrix material.

The invention relates to a flexible article having resistance against ballistic impacts, and in particular to flexible articles of the type that can be worn by a user such as vests.

Such articles are known for example from WO 2001/059397, WO 2007/080113 and WO 2009/151484. These publications describe flexible articles comprising a stack of plies, the plies comprising monolayers containing reinforcing polymeric tapes and a matrix.

The known articles provide good resistance against ballistic impacts and have a reasonable flexibility not to impede the wearer's actions. It was however observed that the characteristics of the known articles can still be improved, e.g. their weight, flexibility, ballistic resistance, deformation under impact, and/or combination thereof.

The aim of the invention may therefore be to provide a flexible article having a suitable combination of properties.

The invention provides a flexible article having resistance against ballistic impacts wherein said article comprises a stack of at least two unconnected plies, each ply containing at least two connected monolayers containing polymeric tapes and wherein said monolayers are free of any matrix material.

The invention also provides a flexible article having resistance against ballistic impacts wherein said article comprises a stack of at least two unconnected plies, each ply containing at least two connected monolayers containing gel-spun UHMWPE tapes and wherein said monolayers are free of any matrix material.

An advantage of the article of the invention may be that it has a suitable combination of properties such as weight, ballistic resistance and flexibility. A further advantage thereof may be that the article of the invention has a suitable weight, as expressed in terms of an areal density (AD), a suitable deformation under impact, in particular a low back face deformation (BFD).

An article comprising monolayers containing polymeric tapes and free of a matrix material is known for example from EP 1 627 719. However this known article is not flexible but instead it is rigid and it does not contain plies comprising monolayers containing polymeric tapes and free of any matrix. Instead, the plies of the article disclosed by EP 1 627 719 comprise a monolayer containing polymeric tapes and a monolayer containing a polymeric film.

The flexibility of the article can be measured by a drape test. An article is considered flexible when it deflects with at least 2 cm at the point of load under a weight of 720 g where the weight is applied seven inches from the support point of the article and where the areal density of the article is 4.85 Kg/m.

By an article having resistance against ballistic impacts is herein understood an article which fulfils the NIJ standard from I to IIIA, as stand alone protective material.

By polymeric tape, hereinafter being simply referred to as tape, is herein understood an elongated article having a length much larger than its transversal dimensions of width and thickness, and the dimension of width larger than the dimension of thickness. By width is herein understood the largest dimension between two points on the perimeter of a cross-section of the tape, said cross-section being perpendicular on the length of the tape. By thickness is herein understood an average distance between two points on the perimeter of said cross-section, said distance being perpendicular on the width of the tape and said distance being measured at different locations, e.g. on at least 10 locations. The width and the thickness of a tape can be measured according to known methods in the art, e.g. with the help of a microscope. Usually a tape has an upper surface and a lower surface and may have also two lateral surfaces joining the upper and the lower surface.

The width of the tapes used in accordance with the invention is preferably at least 4 mm, more preferably at least 10 mm, most preferably at least 20 mm. Advantageous results were obtained when the width of the tapes was between 5 and 50 mm, preferably between 10 and 30 mm. The maximum width of the tapes is only dictated by the purpose of the article of the invention and can be routinely determined by the skilled person. The tapes preferably have a cross sectional aspect ratio of at least 5:1, more preferably at least 20:1, even more preferably at least 100:1 and yet even more preferably at least 1000:1. By cross-sectional aspect is herein understood the ratio of width to thickness.

The thickness of the tapes used in accordance with the invention is preferably at most 500 μm, more preferably at most 250 μm, even more preferably at most 100 μm. Preferably the thickness of the tapes used in accordance with the invention is at least 5 μm, more preferably at least 10 μm, most preferably at least 15 μm. Preferably the thickness of the tape is between 5 and 75 μm, more preferably between 10 and 50 μm, most preferably between 12 and 25 μm.

Tapes suitable for use according with the invention, may be manufactured from polymers chosen from the group consisting of polyamides and polyaramides, e.g. poly(p-phenylene terephthalamide) (known as Kevlar®); poly(tetrafluoroethylene) (PTFE); poly{2,6-diimidazo-[4,5b-4′,5′e]pyridinylene-1,4(2,5-dihydroxy)phenylene} (known as M5); poly(p-phenylene-2,6-benzobisoxazole) (PBO) (known as Zylon®); poly(hexamethyleneadipamide) (known as nylon 6,6), poly(4-aminobutyric acid) (known as nylon 6); polyesters, e.g. poly(ethylene terephthalate), poly(butylene terephthalate), and poly(1,4 cyclohexylidene dimethylene terephthalate); polyvinyl alcohols; and also polyolefins e.g. homopolymers and copolymers of polyethylene and/or polypropylene. The preferred polymers for manufacturing of tapes are polyaramides and high or ultra high molecular weight polyethylene (HMWPE or UHMWPE). Examples of commercial available UHMWPE which have the advantage of being solid state drawable include GUR 4150™, GUR 4120™, GUR 2122™, GUR 2126™ manufactured by Ticona; Mipelon XM 220™ and Mipelon XM 221U™ manufactured by Mitsui; and 1900™, HB312CM™, HB320CM™ manufactured by Montell.

A preferred process for the formation of tapes, in particular polyolefin tapes and more in particular UHMWPE tapes, comprises feeding a polymeric powder, e.g. UHMWPE powder, between a combination of endless belts, compression-moulding the polymeric powder at a temperature below the melting point thereof and rolling the resultant compression-moulded polymer followed by drawing. Such a process is for instance described in EP 0 733 460 A2, which is incorporated herein by reference. If desired, prior to feeding and compression-moulding the polymer powder, the polymer powder may be mixed with a suitable liquid organic compound, e.g. a suitable solvent for said polymer, having a boiling point higher than the melting point of said polymer. Compression moulding may also be carried out by temporarily retaining the polymer powder between the endless belts while conveying them. This may for instance be done by providing pressing platens and/or rollers in connection with the endless belts. Preferably UHMWPE, more preferably solid state drawable UHMWPE, is used in this process.

In a preferred embodiment of the invention, the tapes are gel-spun tapes. By a gel-spun tape is herein understood a tape manufacture with a gel-spinning process, i.e. a process comprising at least the steps of forming a solution of a polymer in a suitable solvent; extruding said solution through dye having at least one slitted orifice, i.e. an orifice in the form of a slit, to form a gel tape, i.e. a tape containing the polymer solution; optionally strentching the gel tape; extracting, drying or evaporating the solvent from the gel tape to form a solid tape; and optionally stretching the solid tape. Advantageous articles of the invention were obtained when the tapes contained thereof were stretched in their gel phase at least 1.5 times, more preferably at least 2.5 times, most preferably at least 3.5 times. The extracting, drying or evaporating the solvent is preferably carried out in a drying oven having prefereably at least one, more preferably at least two zones set at different temperature. Preferably said drying oven has a first and a second zone with the first zone having a temperature lower than the temperature in the second zone. Such a drying oven produced tapes which provided the article of the invention with advantageous properties. Preferred gel-spun tapes are polyolefin gel-spun tapes, more preferably polyethylene gel-spun tapes, most preferably UHMWPE gel-spun tapes. Preferably the UHMWPE used to manufactured gel-spun tapes has an intrinsic viscosity (IV) of at least 3 dl/g, more preferably at least 4 dl/g, most preferably at least 5 dl/g. Preferably the IV is at most 40 dl/g, more preferably at most 25 dl/g, more preferably at most 15 dl/g. Preferably, the UHMWPE has less than 1 side chain per 100 C atoms, more preferably less than 1 side chain per 300 C atoms. Gel spinning processes are described in numerous publications, including EP 0205960 A, EP 0213208 A1, U.S. Pat. No. 4,413,110, GB 2042414 A, GB-A-2051667, EP 0200547 B1, EP 0472114 B1, WO 01/73173 A1, EP 1,699,954 and in “Advanced Fibre Spinning Technology”, Ed. T. Nakajima, Woodhead Publ. Ltd (1994), ISBN 185573 182 7. An advantage of using gel-spun tapes may be that the article of the invention has a good combination of ballistic properties, BFD, AD and flexibility.

The tensile strength of the tapes as measured according to ASTM D2256 is preferably at least 1.2 GPa, more preferably at least 2.5 GPa, most preferably at least 3.5 GPa. The tensile modulus of the tapes as measured according to ASTM D2256 is preferably at least 30 GPa, more preferably at least 60 GPa, most preferably at least 100 GPa. Good results were obtained when the tapes were gel-spun UHMWPE tapes having a tensile strength of at least 2 GPa, more preferably at least 3 GPa. Preferably, the tensile modulus of said gel-spun UHMWPE tapes is at least 50 GPa, more preferably of at least 75 GPa, most preferably at least 100 GPa.

By ply is herein understood a component of the article of the invention comprising at least two monolayers. By unconnected plies is herein understood that the at least two plies forming the article of the invention can move in respect of each other over at least part of their surface. An easier handling of the plies is achieved if the plies are joined at their corners by e.g. gluing, stitching or the like. Preferably, the plies are unconnected to each other over at least 80% of their area, more preferably at least 90%, most preferably at least 95%. In a preferred embodiment, the plies are fully detached from each other, i.e. there are not connections between said plies. An article of the invention according to such embodiment shows a high flexibility and ballistic resistance.

Preferably, the article of the invention contained at least 20 plies, more preferably at least 30 plies. It was observed that even when the number of plies is increased in the article of the invention, said article shows a suitable combination of properties. It is however preferred that the article of the invention contains between 20 and 40 plies, more preferably between 25 and 35 plies. It was observed that even when the number of plies was reduced, the article of the invention showed good ballistic resistance and increased flexibility. The thickness of a ply used in accordance with the invention is preferably at least 10 μm, more preferably at least 30 μm, most preferably at least 50 μm. Preferably said thickness is at between 30 and 200 μm, most preferably between 80 and 130 μm.

An article of the invention having advantageous properties was obtained when each of the at least two plies contains at least 2 monolayer, more preferably at least 3 monolayers, most preferably between 4 and 8 monolayers. Also an advantageous article of the invention was obtained when each of the at least two plies contains between 2 and 4 monolayers.

By monolayer is herein understood a component of a ply, the monolayer comprising a plurality of tapes in a planar arrangement. Preferably, the thickness of a monolayer is between 1 time and 5 times, more preferably between 1 time and 2 times the thickness of the tapes used to form thereof. If tapes with various thicknesses are used to form a monolayer, than by thickness of the tapes is herein understood the average thickness of the tapes. By connected monolayers is herein understood that the at least two monolayer forming a ply are connected over a substantial part of their surface, preferably over at least 80%, more preferably over at least 90% of their surface, most preferably over their entire surface. The monolayers may be connected by stitching or by compressing them at an elevated temperature.

The monolayers used in accordance with the invention are preferably free of any matrix material or any bonding agent. It was observed that by using such monolayers, the article of the invention has a suitable combination of AD, BFD and ballistic performance. If a matrix material is used in the monolayer to facilitate binding the tapes together and improve the cohesion of the monolayer, than the amount of matrix per total weight of a monolayer is preferably at most 25%, more preferably at most 15%, most preferably at most 5%. Suitable matrix materials are very well known in the art of ballistic articles comprising either fibers or tapes.

The monolayers used in accordance with the invention are preferably woven monolayers, more preferably unidirectional monolayers.

Woven monolayer can be obtained by weaving the tapes to form various woven structures, e.g. plain, tabby, basket, twill, crow-feet, satin, triaxial and the like. Advantageous articles were obtained when the woven monolayers were plain woven or basket woven. Preferably the thickness of the woven monolayers is at least 2 times, more preferably the thickness is 2 times the thickness of a tape.

Unidirectional monolayers may be obtained by arranging the tapes along a common direction such that the tapes abut each other along their length or overlap each over part of their surface along their length. By abutting tapes is herein understood that the lateral surfaces of adjacent tapes may touch or that there is a gap between said lateral surfaces of said adjacent tapes. Said gap is preferably at most 1 mm, more preferably at most 0.5 mm, most preferably at most 0.3 mm. Alternatively, the tapes are overlapping tapes, more preferably the length of overlap of two adjacent overlapping tapes is at most 5% of the width of the tapes, most preferably at most 2%. If tapes with different widths are used and overlapped with each other, said length of overlap between two adjacent overlapping tapes is computed with reference to the narrower tape. Preferably the thickness of an unidirectional monolayers comprising non-overlapping tapes is substantially equal with the thickness of the tapes. In case of an unidirectional monolayer comprising overlapping tapes, the thickness of said monolayer is preferably at most 2 times the thickness of the tapes, more preferably at most 1.5 times the thickness of the tapes. By thickness of the tapes is herein understood the average thickness of the tapes used to manufacture a monolayer.

The at least two monolayers used according to the invention may be connected according to well known processes in the art.

In a preferred embodiment, the at least two monolayers forming a ply as used according to the invention are stacked and compressed under elevated pressure at a temperature (T) below the melting temperature (Tm) of the tapes to form a ply. The Tm may be measured with DSC. Preferably the elevated pressure is at least 100 bar, more preferably at least 150 bar. Preferably the temperature (T) fulfills the conditions Tm−50° C.<T<Tm; more preferably Tm−30° C.<T<Tm; most preferably Tm−10° C.<T<Tm. Such process produces a ply comprising fully connected monolayers, i.e. monolayers connected over their entire surface. With the term melting temperature (Tm), also referred to as the melting point, is herein understood the temperature, measured according to ASTM D3418-97 by DSC with a heating rate of 20° C./min, falling in the melting range and showing the highest melting rate.

The invention also relates to a process for producing the flexible article of the invention, the process comprising, in sequence, the steps of:
a. Providing a plurality of monolayers containing tapes;
b. Grouping by stacking said plurality of monolayers in groups containing at least two stacked monolayers to create at least two groups, each of said groups having an upper side and a lower side;
c. Stacking said groups together with a release foil positioned between the upper side of each group and the lower side of each adjacent group;
d. Compressing the stacked groups under an elevated pressure (P) at an elevated temperature (T) to connect to each other the monolayers forming each group, to obtain a pressed stacked groups;
e. Cooling the pressed staked groups and subsequently releasing the pressure applied on said pressed stacked groups; and
f. removing the release foil to obtain a flexible article comprising a stack of at least two unconnected plies, each ply comprising at least two connected monolayers.

The tapes used in the process of the invention are preferably UHMWPE tapes, more preferably gel-spun UHMWPE tapes.

The monolayers at step a) of the process of the invention are preferably free of any matrix material.

It was observed that advantageous results were obtained when the compression at step d) of the process of the invention and preferably also the cooling and subsequent releasing of pressure in the step e) thereof are carried out in vacuum.

Preferably, the groups at step d) of the process of the invention are compressed under an elevated pressure (P) of at least 100 bar, more preferably of at least 150 bar. The elevated temperature (T) at which said groups are compressed is preferably at most the melting temperature (Tm) as measured by DSC of the tapes used to construct the monolayers. Preferably the temperature (T) fulfills the conditions Tm−50° C.<T<Tm; more preferably Tm−30° C.<T<Tm; most preferably Tm−10° C.<T<Tm.

Any release foil may be used in the process of the invention. Preferably silicon coated release paper is used and positioned with the silicon coated towards the surface of the monolayer in contact thereof. If the release paper is single coated, two such papers positioned with the silicon coatings toward outside may be used in between two groups when stacking said groups at step c) of the process of the invention. A commercial example of silicon coated release paper can be purchased from Laufenberg Papierveredlung (DE).

The article of the invention may be used in a bullet-proof vest. Thus the invention relates to a bullet-proof vest containing the article of the invention. A bullet-proof vest according to the invention is lightweight, flexible and provides a good protection in terms of ballistic resistance and BFD.

The article of the invention may also be suitably used in sails, inflatable structures, tarpaulins, covers, tents and architectural applications. Therefore the invention relates also to the above mentioned articles comprising the article of the invention.

The invention will be further explained with the help of the following

Example and Comparative Experiment without being however limited thereto.

### EXAMPLES AND COMPARATIVE EXPERIMENTS

### Production of Tape

An UHMWPE with an intrinsic viscosity of 20 was mixed with a solvent to become a 7 wt % suspension in decaline. The suspension was fed to an extrude and mixed at a temperature of 170° C. to produce a homogeneous gel. The gel was then fed through a slot die with a width of 600 mm and a thickness of 800 μm. After being extruded through the slot die, the gel was quenched in a water bath thus creating a gel-tape. The gel-tape was stretched with a factor of 3.85 after which the tape was dried in an oven consisting of two parts, one at 50° C. and one at 80° C. until the amount of decaline in the tape was below 1%. This dried gel tape was wound on a coil for later treatment.

The later treatment consisted of two stretching steps. The first stretching step was performed with a length of 20 m tape in an oven at 140° C., with a stretching ratio of 5.8. The tape was reeled up and fed through an oven again. The second stretching step was performed at an oven temperature of 150° C. to achieve an additional stretching ratio of 6.

The resulting tape had a width of 20 mm and a thickness of 12 μm.

### Example A

A number of 6 monolayers were stacked on each other, each monolayer consisting of a number of abutting tapes positioned such that the largest gap between the tapes was at most 0.5 mm.

The monolayers were placed between two silicon coated papers, the silicon coating facing the tapes.

A number of 30 of the above stacks was place on top of each other to create the final stack of monolayers.

The dimensions of a monolayer and hence of a stack of monolayers were 40×40 cm (L×W). The thickness of a monolayer was 1× the thickness of the tapes.

The final stack of monlayers was introduced in a vacuum bag and the air was evacuated. The entire assembly was then pressed at 300 bar and at a temperature of 145° C. during 45 minutes. The heating and cooling of the press were done in vacuum too and under pressure, thus avoiding the situation of a hot product at a temperature above 80° C. without pressure.

After pressing, the stack was separated by removing the silicon papers and 30 plies of 6 consolidated monolayers were obtained. The plies of 40×40 cm were stitched at the corners in order to keep them together during subsequent shooting trials. The aerial density (AD) of the entire stack was 2.7 kg/m².

### Example B

The tapes forming a monolayer were woven into a fabric having a plain weave structure. The fabric was cut with a thermal knife to provide fabric sheets of 40×40 cm. Three fabric sheets were placed on top of each other and sandwiched between two silicone coated papers with the silicon layer facing the tapes.

The thickness of a monolayer was 2× the thickness of the tapes.

A number of 30 of the above stacks was place on top of each other to create the final stack of monolayers.

The final stack of monolayers was processed as in Example A to create an assembly of 30 plies. The measured AD of the stack was 3 kg/m².

### Comparative Experiment

23 layers of commercial bullet resistant material known as SB21 and sold by DSM Dyneema, NL, were stacked to obtain a stack with an AD of 3.4 kg/m².

### Shooting Experiments

An assembly of plies was placed in front of a container containing plastiline clay (Caran d'Ache), that simulates the behavior of a human body. Subsequently it was subjected to shooting trials with 9 mm Parabellum, 17 grain (1.1 grams) Fragment Simulating Projectiles (FSP).

Shooting trials were performed in order to obtain a so called V50 speed, which is the speed at which 50% of the bullets perforate the stack.

The V50 was used to calculate a so called energy absorption (Eabs). Eabs is the kinetic energy of a bullet at speed V50, divided by the aerial density (AD) of the stack.

The indentation in the human body that is caused by a stopped bullet was quantified with the help of a performance parameter P against indentation (also called trauma) computed according to the following formula:

P=V/(D*AD) m²/(kg sec)

where D is the measured indentation depth in the plastiline clay of a stopped bullet and V is the shooting speed of that stopped bullet. A higher P is a better result

The results are presented in the Table:

TABLE

| | | | Trauma (9 mm) | | | | |
|---|---|---|---|---|---|---|---|
| | | | | | P | | |
| | V50 | Eabs | | | average | V50 | Eabs |
| | (9 mm) | (9 mm) | V | D | m²/(kg | (FSP) | (FSP) |
| | m/s | J/(kg/m²) | (m/s) | (mm) | sec) | m/s | J/(kg/m²) |
| Ex A | 506 | 381 | 502 | 42 | 4160 | — | — |
| | | | 514 | 49 | | | |
| Ex B | 530 | 375 | — | — | — | 514 | 48 |
| C. Exp | 440 | 228 | 447 | 45 | 3070 | 431 | 30 |
| | | | 429 | 39 | | | |

From the above Table it can be seen that the Trauma factor P of the articles of the invention are higher than that of known articles. Also the articles of the invention have a better ballistic resistance in terms of Eabs and/or V50. A further advantage of the article of the invention is that it shows simultaneously an Eabs against 9 mm Parabellum bullets larger than 350 J/(kg/m²) and/or an Eabs against 19 grain FSP larger than 40 J/(kg/m²), together with a factor P larger than 3500 m²/(kg sec).

1. A flexible article having resistance against ballistic impacts wherein said article comprises a stack of at least two unconnected plies, each ply containing at least two connected monolayers containing polymeric tapes and wherein said monolayers are free of any matrix material.

2. A flexible article having resistance against ballistic impacts wherein said article comprises a stack of at least two unconnected plies, each ply containing at least two connected monolayers containing gel-spun UHMWPE tapes and wherein said monolayers are free of any matrix material.

3. The article of claim 1 wherein each ply contains at least 3 monolayers.

4. The article of claim 1 wherein each ply contains between 2 and 4 monolayers.

5. The article of claim 1 wherein the tensile strength of the tapes as measured according to ASTM D2256 is at least 1.2 GPa.

6. The article of claim 1 wherein the thickness of the tapes is at most 250 μm.

7. The article of claim 1 wherein the monolayers contain unidirectionally aligned tapes, said tapes abutting each other.

8. The article of claim 1 wherein the monolayers contain unidirectionally aligned tapes, said tapes abutting each other and wherein a gap of at most 0.5 mm exists between the tapes.

9. The article of claim 1 wherein adjacent tapes partially overlap each other.

10. The article of claim 1 wherein the monolayers contain woven tapes.

11. A process for producing a flexible article having resistance against ballistic impacts comprising in the following sequence the steps of:
a. Providing a plurality of monolayers containing gel-spun UHMWPE tapes and wherein said monolayers are free of any matrix material;
b. Grouping said plurality of monolayers in groups containing at least two monolayers to create at least two groups, each of said groups having an upper side and a lower side;
c. Stacking said groups together with a release foil positioned between the upper side of each group and the lower side of each adjacent group;
d. Pressing the stacked groups at an elevated temperature and pressure to bind the monolayers forming each group to each other;
e. Cooling and releasing the pressed stacked groups and removing the release foil to obtain a flexible article comprising a stack of at least two unconnected plies, each ply comprising at least two connected monolayers.

12. The process of claim 11 wherein the pressing takes place at a pressure of at least 100 bars and at an elevated temperature below the melting temperature of the tapes.

13. A bullet proof-vest containing the article of claim 1.

14. Sails, inflatable structures, tarpaulins, covers, tents and architectural applications containing the article of claim 1.
